(19) United States
(12) Patent Application Publication
(10) Pub. No.: US 2026/0268552 A1
(43) Pub. Date: Sep. 10, 2026

(54) METHOD, APPARATUS, ELECTRONIC DEVICE AND STORAGE MEDIUM FOR PAGE DISPLAY

(71) Applicant: Beijing Zitiao Network Technology Co., Ltd., Beijing (CN)

(72) Inventors: Yimeng ZHANG, Beijing (CN); Guanqiao WANG, Beijing (CN)

(21) Appl. No.: 19/157,664

(22) PCT Filed: Jul. 25, 2024
(86) PCT No.: PCT/CN2024/107666

§ 371 Date: Aug. 18, 2025

(30) Foreign Application Priority Data
Aug. 7, 2023 (CN) 202310989123.1

(51) Int. Cl. G06T 11/60; G06T 11/10

(52) U.S. Cl. CPC G06T 11/60; G06T 11/10

(57) ABSTRACT

Embodiments of the disclosure relate to page display. A method includes: receiving a display operation for a predetermined page; displaying, in response to the display operation, the predetermined page, displaying a background image in a background region of the predetermined page and displaying a predetermined foreground object in a foreground region of the predetermined page, wherein the background region comprises a first sub-region and a second sub-region, the first sub-region is an associated sub-region of the foreground region in the background region, the background image displayed in the first sub-region is a gradient image, a gradient color corresponding to the gradient image is associated with a dominant color of a first picture region in a predetermined picture and a predetermined display color of the predetermined foreground object, and the background image displayed in the second sub-region is an original image of a second picture region in the predetermined picture.

### CROSS-REFERENCE TO RELATED APPLICATION(S)

This application is a U.S. National Stage application based on International Application No. PCT/CN 2024/107666, as filed on Jul. 25, 2024, which claims the benefit of Chinese Patent Application No. 202310989123.1, filed Aug. 7, 2023, entitled “METHOD, APPARATUS, ELECTRONIC DEVICE AND STORAGE MEDIUM FOR PAGE DISPLAY”, the contents of which are incorporated herein by reference in their entireties.

### FIELD

Embodiments of the present disclosure relate to the field of computer technologies, and in particular, to a method, apparatus, electronic device and storage medium for page display.

### BACKGROUND

At present, in some applications, a background image in a part of regions of a background picture is adjusted to ensure that a foreground object located on an upper layer of the background picture can be clearly displayed. However, the adjusted background image is not coordinated with the original image of the background picture, resulting in poor overall display effect of the background image.

### SUMMARY

Embodiments of the present disclosure provide a method, apparatus, electronic device and a storage medium for page display, to improve coordination between the adjusted background image and the original image of the background picture.

According to a first aspect, embodiments of the present disclosure provide a method for page display, including: receiving a display operation for a predetermined page; displaying, in response to the display operation, the predetermined page, displaying a background image in a background region of the predetermined page and displaying a predetermined foreground object in a foreground region of the predetermined page, wherein the background region comprises a first sub-region and a second sub-region, the first sub-region is an associated sub-region of the foreground region in the background region, the background image displayed in the first sub-region is a gradient image, a gradient color corresponding to the gradient image is associated with a dominant color of a first picture region in a predetermined picture and a predetermined display color of the predetermined foreground object, and the background image displayed in the second sub-region is an original image of a second picture region in the predetermined picture.

According to a second aspect, embodiments of the present disclosure further provide an apparatus for page display, including: an operation receiving module configured to receive a display operation for a predetermined page; and a page displaying module configured to display, in response to the display operation, the predetermined page, display a background image in a background region of the predetermined page, and display a predetermined foreground object in a foreground region of the predetermined page, wherein the background region comprises a first sub-region and a second sub-region, the first sub-region is an associated sub-region of the foreground region in the background region, the background image displayed in the first sub-region is a gradient image, a gradient color corresponding to the gradient image is associated with a dominant color of a first picture region in a predetermined picture and a predetermined display color of the predetermined foreground object, and the background image displayed in the second sub-region is an original image of a second picture region in the predetermined picture.

In a third aspect, embodiments of the present disclosure further provide an electronic device, including: one or more processors; and a memory configured to store one or more programs. When the one or more programs are executed by the one or more processors, the one or more processors implement the method for page display according to the embodiments of the present disclosure.

In a fourth aspect, embodiments of the present disclosure further provide a computer-readable storage medium having a computer program stored thereon. The program, when executed by a processor, implements the method for page display according to the embodiments of the present disclosure.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It should be understood that the drawings are schematic, and elements and elements are not necessarily drawn to scale.

FIG. 1 is a schematic flowchart of a method for page display according to embodiments of the present disclosure;

FIG. 2 is a schematic diagram of a predetermined page according to embodiments of the present disclosure;

FIG. 3 is a schematic flowchart of another method for page display according to embodiments of the present disclosure;

FIG. 4 is a schematic diagram of a predetermined picture according to embodiments of the present disclosure;

FIG. 5 is a structural block diagram of an apparatus for page display according to embodiments of the present disclosure;

FIG. 6 is a schematic structural diagram of an electronic device according to embodiments of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein, and vice versa. It should be understood that the drawings and embodiments of the present disclosure are for exemplary purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprising” and variations thereof are open-ended, i.e., “including but not limited to”. The term “based on” is “based at least in part on”. The term “one embodiment” means “at least one embodiment”; the term “another embodiment” means “at least one further embodiment”; the term “some embodiments” means “at least some embodiments”. The relevant definitions of other terms will be given below.

It should be noted that the concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in this disclosure is illustrative and not limiting, and those skilled in the art should understand that “one or more” should be understood unless the context clearly indicates otherwise.

The names of messages or information exchanged between multiple devices in embodiments of the present disclosure are for illustrative purposes only and are not intended to limit the scope of such messages or information.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, the user can autonomously select whether to provide personal information to software or hardware executing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “disagree” to provide personal information to the electronic device.

It may be understood that the foregoing notification and obtaining a user authorization process is merely illustrative, and does not constitute a limitation on implementations of the present disclosure, and other manners of meeting related laws and regulations may also be applied to implementations of the present disclosure.

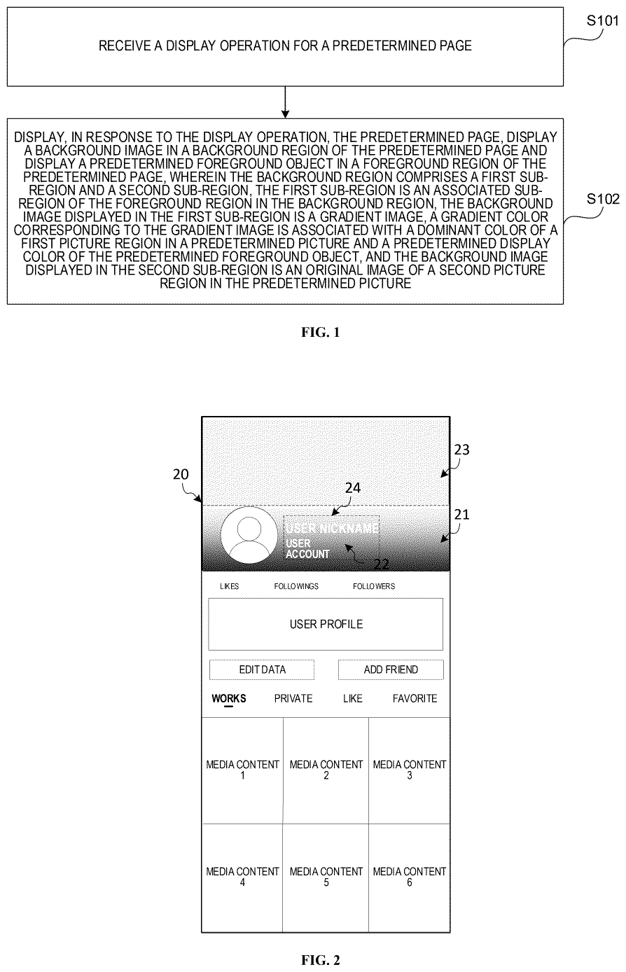

FIG. 1 is a schematic flowchart of a method for page display according to embodiments of the present disclosure. The method may be performed by an apparatus for page display, where the apparatus may be implemented by software and/or hardware, may be disposed in an electronic device, and may be typically configured in a mobile phone or a tablet computer. The method for page display provided by embodiments of the disclosure is suitable for a scenario where a background image and a foreground object are displayed in a page, for example, a scenario where a background image is displayed in a page and a predetermined foreground object is displayed on an upper layer of the background image.

In some applications, a user is enabled to set a predetermined picture. However, because the color of the predetermined picture set by the user is not fixed, if the foreground object is directly displayed above the predetermined picture by using a predetermined display color for the foreground object, it may appear that the foreground object cannot be clearly displayed. Therefore, in the prior art the background image in a region overlapping with the foreground object is generally adjusted to cause the foreground object to be clearly displayed.

However, the manner of adjusting the background image in the prior art causes a situation that the adjusted background image is not coordinated with the original image of the predetermined picture. For example, the overall image of the predetermined picture is darker, but the image color of the adjusted background image is brighter; the overall image color of the predetermined picture is darker, but the image color of the background image obtained through the adjustment is lighter; or, the overall saturation and lightness of the predetermined picture is low, but the saturation and/or lightness of the adjusted background image is too high, and so on.

Therefore, the embodiments provide a method for page display, to resolve the foregoing at least one technical problem in the prior art, and to improve coordination between the adjusted background image and the original image of the predetermined picture.

As shown in FIG. 1, the method for page display provided in the embodiments may include the following steps:

S101: receive a display operation for a predetermined page.

The predetermined page may be an object including a background image, for example, a page where a user is enabled to set a predetermined picture and there is a foreground object to be displayed in a display region of the predetermined picture. Take a profile page as an example of the predetermined page in the following. The display operation may be an operation for indicating to display a predetermined page, for example, an operation of switching from another page into a predetermined page.

In the embodiments, the current user may instruct the current application to display the predetermined page by performing the display operation for the predetermined page, and correspondingly, the current application may receive the display operation performed by the current user.

S102, in response to the display operation, a predetermined page is displayed, a background image is displayed in a background region of the predetermined page and a predetermined foreground object is displayed in a foreground region of the predetermined page. The background region comprises a first sub-region and a second sub-region. The first sub-region is an associated sub-region of the foreground region in the background region, the background image displayed in the first sub-region is a gradient image, a gradient color corresponding to the gradient image is associated with a dominant color of a first picture region in a predetermined picture and a predetermined display color of the predetermined foreground object, and the background image displayed in the second sub-region is an original image of a second picture region in the predetermined picture.

The background region may be considered as a region in the predetermined page for displaying the background image, in other words, the region in which the background image is displayed. The background region may include a first sub-region and a second sub-region. The first sub-region may be an associated sub-region of the foreground region in the background region, that is, a sub-region associated with the foreground region in the background region, for example, a sub-region with an upper layer in which the predetermined foreground object needs to be displayed. The second sub-region may be considered as a sub-region other than the first sub-region in the background region.

In addition, the background region may further include a third sub-region, the third sub-region may be considered as a display region corresponding to the first picture region in the background region, and the first sub-region may be located within the third sub-region. That is, the gradient image displayed in the first sub-region may be determined based on the dominant color of the third sub-region including the first sub-region in the predetermined picture. In this case, optionally, the first sub-region is located within the third sub-region of the background region, and the third sub-region is a display region corresponding to the first picture region in the background region.

The background image displayed in the first sub-region is a gradient image, for example, an image gradually changing from the original image of the predetermined picture to the dominant color of the first picture region in the predetermined picture. The original image may be, for example, an original image located within the first sub-region when the predetermined picture is displayed in the background region. For example, the background image displayed in the first sub-region may be an image formed by superimposing and filling a gradient mask of the gradient color on the original image of the corresponding picture region in the predetermined picture.

The background image displayed in the second sub-region may be the original image of the corresponding picture region in the predetermined picture, for example, the original image in the second picture region in the predetermined picture.

The predetermined foreground object may be a foreground object to be displayed in the predetermined page, for example, a foreground object at least partially displayed in the background region. The foreground region may be considered as a region in which the predetermined foreground object is displayed in the predetermined page. There may be an overlapping region between the foreground region and the background region in the predetermined page. Optionally, an overlapping region is present between the background region and the foreground region, and the overlapping region is located within the first sub-region. In other words, the first sub-region may be a sub-region in the background region that includes the overlapping region with the foreground region.

The predetermined picture may be an original picture that needs to be displayed as a background in the background region, and the original picture may be set by a user corresponding to the predetermined page. For example, when the predetermined page is a profile page of a certain user, the predetermined picture may be selected and/or uploaded by the user. The predetermined picture includes a first picture region and a second picture region. The first picture region may be a picture region corresponding to the image within the third sub-region of the background region when the picture is displayed in the background region, that is, when the predetermined picture is displayed in the background region, the image in the first picture region is displayed in the third sub-region of the background region. The second picture region may be a picture region corresponding to the image within the second sub-region of the background region when the picture is displayed in the background region, that is, when the predetermined picture is displayed in the background region, the image within the second picture region is displayed within the second sub-region of the background region. Optionally, the first picture region and the second picture region may be different picture regions of the predetermined picture, and the first picture region and the second picture region may or may not have an overlapping region. The size of the predetermined picture may be the same as the size of the background region, and when the sizes of the predetermined picture and the background region are different, the predetermined picture may be adjusted to have the same size as the background region.

The predetermined foreground object may be a foreground object for which a display region is associated with the background region, for example, a foreground object for which the display region has an overlapping region with the background region. The foreground object may be understood as an object displayed on an upper layer of the background image, and the object may be, for example, a character, a card, an image, or the like, and the type of the predetermined foreground object is not limited in the embodiments. The foreground region may be a display region of the predetermined foreground object in the predetermined page, that is, a region in the predetermined page for displaying the predetermined foreground object.

Specifically, when the display operation performed by the user for the predetermined page is received, the predetermined page may be displayed. The gradient image associated with the dominant color of the first picture region in the predetermined picture and the predetermined display color of the predetermined foreground object is displayed in the first sub-region of the background region of the predetermined page. The original image of the second picture region in the predetermined picture is displayed in the second sub-region of the background region of the predetermined page. The predetermined foreground object is displayed in the foreground region of the predetermined page by using the predetermined display color.

Taking the predetermined page being a profile page of a user as an example, the predetermined page may include a header map region. The header map region may be used to display a predetermined picture set by the user and part of information of the user. The part of information may include, for example, an avatar, a nickname, and/or an account of the user. In this case, the background region may be the header map region, the predetermined picture may be a picture set by the user in the header map region and displayed as a background, and the predetermined foreground object may be information such as a user nickname and/or an account displayed in the header map region.

Therefore, as shown in FIG. 2, when the profile page of a certain user is displayed based on the display operation of the current user, a gradient image may be displayed in the first sub-region 21 of the background region 20 of the profile page, and the gradient color corresponding to the gradient image is associated with the dominant color of the first picture region in the predetermined picture and the predetermined display color of the predetermined foreground object 22. The original image of the second picture region in the predetermined picture is displayed in the second sub-region 23 of the background region 20 of the profile page; and the predetermined foreground object 22 is displayed in the foreground region 24 of the profile page (taking the predetermined foreground object as the nickname and account of the user as an example in FIG. 2).

In the embodiments, the gradient color used for adjusting the background image is determined according to the dominant color of a certain picture region in the predetermined picture, such that the situation that the color change between the background image obtained through the adjustment and the original image of the predetermined picture is too abrupt can be avoided, thus the color continuity is more natural when the adjusted background image and the original image of the predetermined picture are displayed in the background region, thereby improving the coordination between the adjusted background image and the original image of the predetermined picture, and further improving the overall display effect of the background image in the background region.

In the embodiments, the display manner of the background image in the background region may be flexibly set.

In some embodiments, the determined gradient color may be used to adjust the predetermined picture to obtain a target picture. For example, the predetermined picture set by the user may be obtained; the gradient color corresponding to the gradient image is obtained according to the dominant color of the first picture region in the predetermined picture and the predetermined display color of the predetermined foreground object; the gradient color is filled in a picture region of the predetermined picture that corresponds to the first sub-region of the background region to obtain the target picture; and the target picture is displayed in the background region.

In some embodiments, the determined gradient color may also be directly displayed on the upper layer of the predetermined picture. For example, the background image is obtained by superimposing a gradient mask layer on the upper layer of the predetermined picture, and a region of the gradient mask layer that corresponds to the first sub-region is filled with the gradient color. In this case, optionally, the background image is obtained by superimposing a gradient mask layer on an upper layer of the predetermined picture, and the gradient color is filled in a region corresponding to the first sub-region in the gradient mask layer.

According to the method for page display provided in the embodiments, a display operation for a predetermined page is received. In response to the display operation, a predetermined page is displayed, a background image is displayed in a background region of the predetermined page, and a predetermined foreground object is displayed in a foreground region of the predetermined page. The background region includes a first sub-region and a second sub-region, the first sub-region is an associated sub-region of the foreground region in the background region, the background image displayed in the first sub-region is a gradient image, a gradient color corresponding to the gradient image is associated with a dominant color of the first picture region in the predetermined picture and a predetermined display color of the predetermined foreground object, and a background image displayed in the second region is an original image of the second picture region in the predetermined picture. By adopting the solution, the gradient color used for adjusting the background image is determined according to the dominant color in a certain picture region of the predetermined picture, such that the situation that the color change between the background image obtained through the adjustment and the original image of the predetermined picture is too abrupt can be avoided. Thus the coordination between the adjusted background image and the original image of the predetermined picture is improved, and the overall display effect of the background image in the background region is improved.

FIG. 3 is a schematic flowchart of another method for page display according to embodiments of the present disclosure. The solution in the embodiments may be combined with one or more optional solutions in the foregoing embodiments. Optionally, before displaying the background image in the background region of the predetermined page, the method further includes: obtaining a dominant color of a first picture region in the predetermined picture; determining a target color according to the dominant color; and generating a gradient color corresponding to the target color as the gradient color corresponding to the gradient image.

Correspondingly, as shown in FIG. 3, the method for page display provided in the embodiments may include the following steps.
S201: A display operation for a predetermined page is received.
S202: A dominant color of a first picture region in a predetermined picture is obtained in response to the display operation.

Specifically, the current application may obtain or obtain by using the server, the dominant color of the first picture region in the predetermined picture.

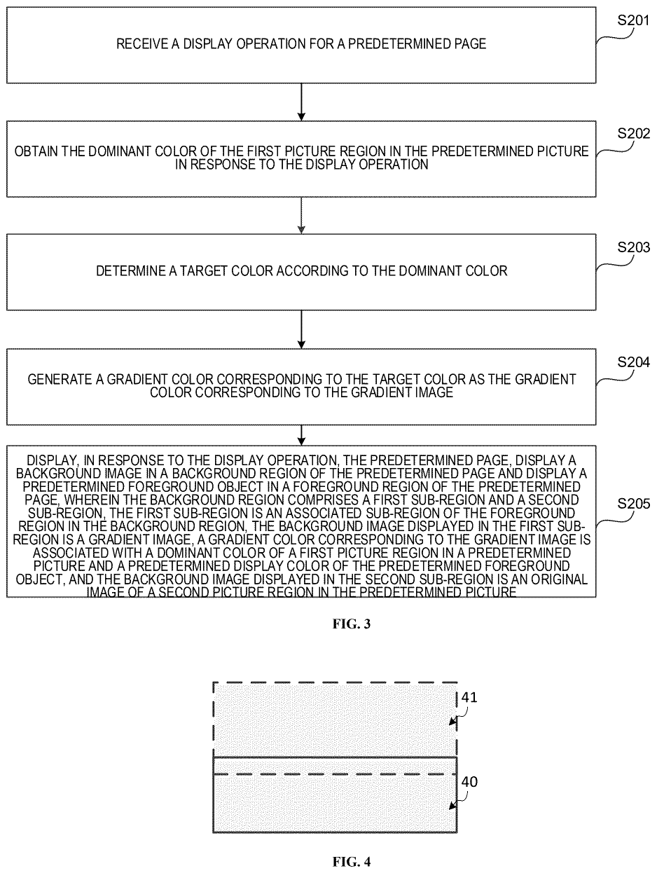

When obtaining the dominant color of the first picture region in the predetermined picture, for example, the first picture region 40 in the predetermined picture (the region enclosed by the solid line in FIG. 4) may be determined; the color of each pixel in the first picture region 40 in the predetermined picture is obtained; for each color having a corresponding pixel in the first picture region 40, the number of pixels with this color in the first picture region 40 is determined, and the color with the largest number of pixels is determined as the dominant color of the first picture region 40 in the predetermined picture.

The specific size and the position of the first picture region 40 are not limited, for example, a region of the bottom half of the predetermined picture may be used as the first picture region 40. In addition, as shown in FIG. 4, the predetermined picture may further include a second picture region 41 (a region enclosed by a dotted line in FIG. 4), and the first picture region 40 and the second picture region 41 may or may not have an overlapping region. For example, there may be an overlapping boundary line but no overlapping region present between the first picture region 40 and the second picture region 41. Alternatively, an overlapping region may be present.

S203: A target color is determined according to the dominant color.

In the embodiments, after determining the dominant color of the first picture region in the predetermined picture, the target color for generating the gradient color may be determined according to the dominant color.

In some implementations, determining the target color according to the dominant color includes at least one of: keeping a hue of the dominant color unchanged, and reducing a saturation and a lightness of the dominant color to obtain the target color in accordance with a color contrast between the predetermined display color of the foreground object and the dominant color being greater than or equal to a predetermined contrast threshold; keeping the hue of the dominant color unchanged, adjusting the saturation of the dominant color to a first saturation value, and adjusting the lightness of the dominant color to a first lightness value to obtain the target color in accordance with the color contrast between the predetermined display color of the foreground object and the dominant color being less than the predetermined contrast threshold, the saturation of the dominant color being less than or equal to a first saturation threshold, and the lightness of the dominant color being greater than or equal to a first lightness threshold.

In the foregoing implementation, the adjustment manner of the dominant color may be determined based on the color contrast between the predetermined display color of the foreground object and the dominant color of the first picture region and the saturation and the lightness of the dominant color of the first picture region. The color obtained by adjusting the dominant color is determined as the target color used to generate the gradient color.

Specifically, after determining the dominant color of the first picture region of the predetermined picture, the color contrast between the predetermined display color of the predetermined foreground object and the dominant color may be calculated.

If the color contrast is greater than or equal to a predetermined contrast threshold, the hue of the dominant color is kept unchanged, and the saturation and lightness of the dominant color is reduced. For example, the saturation of the dominant color is reduced by a certain set saturation value, and the lightness of the dominant color is reduced by a certain set lightness value such that the target color is obtained.

If the color contrast is less than the predetermined contrast threshold, it is further determined whether the saturation of the dominant color is less than or equal to the first saturation threshold and the lightness of the dominant color is greater than or equal to the first lightness threshold. If yes, the hue of the dominant color is kept unchanged, the saturation of the dominant color is adjusted to the first saturation value, and the lightness of the dominant color is adjusted to the first lightness value such that the target color is obtained. If no, the background image may be adjusted by using the existing background image adjustment manner.

Therefore, the situation that the overall image color of the predetermined picture is relatively dark, but the color of the background image obtained through adjustment is relatively light and/or the situation that the saturation and/or the lightness of the obtained background image is too high compared with the original image of the background picture can be avoided. The coordination between the adjusted background image and the original image of the predetermined picture is further improved.

The calculation manner of the color contrast and the existing background image adjustment manner are not limited, and the predetermined contrast threshold, the first saturation threshold, the first lightness threshold, the first saturation value and the first lightness value, and the reduced saturation value and the set lightness value may be set as needed, as long as the above effects can be achieved. For example, when the predetermined display color of the predetermined foreground object is white, the color contrast may be set to 7.3, 7.33, or 7.36, the first saturation threshold may be set to a numerical value such as 24, 25, or 26, the first saturation value may be set to a numerical value such as 0, 1, or 2, the first lightness threshold may be set to a numerical value of 75, 80, or 85, and the first lightness value may be set to a numerical value such as 35, 40, or 45.

Considering an example where the first picture region is the region of the bottom half of the predetermined picture, the predetermined display color of the predetermined foreground object is white, the color contrast is 7.33, the reduced saturation value and the set lightness value is 10, the first saturation threshold is 25, the first lightness threshold is 8, the first saturation value is 0, and the first lightness value is 40, the process of determining the target color may be described as:
a1: obtaining an RGB value (that is, a red color component value, a green color component value, and a blue color component value) of the dominant color of the bottom half region the predetermined picture;
a2: converting the dominant color from the RGB mode to the HEX mode, calculating a color contrast between the predetermined display color and the dominant color, and performing a3 or a4.
a3: If the color contrast is greater than or equal to 7.33:1, the dominant color is converted from the RGB mode to the HSLuv mode, that is, the hue value H1, the saturation value S1 and the lightness value L1 of the dominant color in the HSLuv mode are calculated. Thus, the color values (H2, S2, L2) of the target color in the HSLuv mode may be (H1, S1-10, L1-10), and the target color may be further converted from the HSLuv mode to the HSB mode to facilitate subsequent generation of the gradient color.
a4: If the color contrast is less than 7.33:1, it is determined whether the color value of the dominant color in the HSLu v mode satisfies S1≤25 and L1≥80. If yes, the color value (H2, S2, L2) of the target color in the HSLu v mode may be (H1, 0, 40), and the target color may be further converted from the HSLuv mode to the HSB mode, so as to facilitate subsequent generation of the gradient color. If no, the background image may be adjusted in the existing background image adjustment manner.

In some embodiments, the predetermined display color of the predetermined foreground object is white, and the determining a target color according to the dominant color includes at least one of: if the saturation of the dominant color is less than or equal to a second saturation threshold, and the lightness of the dominant color is greater than or equal to the second lightness threshold, keeping the hue of the dominant color unchanged, adjusting the saturation of the dominant color to a second saturation value, and reducing the lightness of the dominant color to obtain the target color; if the saturation of the dominant color is greater than the second saturation threshold, or the lightness of the dominant color is less than the second lightness threshold, determining the dominant color as the target color.

In the foregoing implementation, when the predetermined display color of the predetermined foreground object is white, the adjustment manner of the dominant color may also be determined based on the saturation value and the lightness value of the dominant color of the first image region. The color obtained by adjusting the dominant color is determined as the target color used to generate the gradient color, so as to avoid a situation where the color of the predetermined image is relatively light, and the color of the background image obtained through adjustment is relatively dark.

Specifically, after determining the dominant color of the first picture region of the predetermined picture, it may be determined whether the saturation of the dominant color is less than or equal to the second saturation threshold and the lightness of the dominant color is greater than or equal to the second lightness threshold. If yes, the hue of the dominant color is kept unchanged, the saturation of the dominant color is adjusted to a predetermined second saturation threshold, and the lightness of the dominant color is reduced, for example, by a certain set lightness value, such that the target color is obtained. If no, the dominant color may be determined as the target color.

The second saturation threshold and the second lightness threshold and the reduced set lightness value may be set as needed. For example, the second saturation value may be set to a value of 18, 20, or 22, the second lightness threshold may be set to a value of 90, 95, or 100, and the set lightness value set may be set to 4, 5, or 6.

Considering an example where the first picture region is the region of the bottom half of the predetermined picture, the second saturation value is 120, the second lightness threshold is 95, and the set lightness value is 4, the process of determining the target color may be described as:
b1: obtaining an RGB value (that is, a red color component value, a green color component value, and a blue color component value) of the dominant color of the region at the bottom half of the predetermined picture;
b2: converting the dominant color from the RGB mode to the HSLuv mode, that is, calculating the hue value H1, the saturation value S1, and the lightness value L1 of the dominant color in the HSLuv mode;
b3: determining whether the color value of the dominant color in the HSLuv mode satisfies S1≤20 and L1≥95. If yes, the color value (H2, S2, L2) of the target color in the HSLuv mode may be (H1, 0, L1-5), and the target color may be further converted from the HSLuv mode to the HSB mode to facilitate subsequent generation of the gradient color. If no, the dominant color may be determined as the target color.

S204: A gradient color corresponding to the target color is generated as the gradient color corresponding to the gradient image.

In the embodiments, after the target color is obtained, gradient processing may be performed on the target color to obtain the gradient color corresponding to the gradient image, to facilitate subsequent generation of the gradient image based on the gradient color.

S205: A predetermined page is displayed, a background image is displayed in a background region of the predetermined page, and a predetermined foreground object is displayed in a foreground region of the predetermined page. The background region includes a first sub-region and a second sub-region, the first sub-region is an associated sub-region of the foreground region in the background region, the background image displayed in the first sub-region is a gradient image, a gradient color corresponding to the gradient image is associated with a dominant color of a first picture region in a predetermined picture and a predetermined display color of the predetermined foreground object, and the background image displayed in the second sub-region is an original picture of a second picture region in the predetermined picture.

It should be noted that the execution sequence of S201 to S205 is not limited. For example, before receiving the display operation for the predetermined page, the gradient color corresponding to the predetermined page may be determined based on the predetermined picture set in the predetermined page and stored in the server. Therefore, after receiving the display operation for the predetermined page, the current application may obtain the gradient color corresponding to the predetermined page from the server, and display the predetermined page.

According to the method for page display provided by the embodiments, the coordination between the adjusted background image and the original image of the predetermined picture can be improved, and the overall display effect of the background image in the background region is improved.

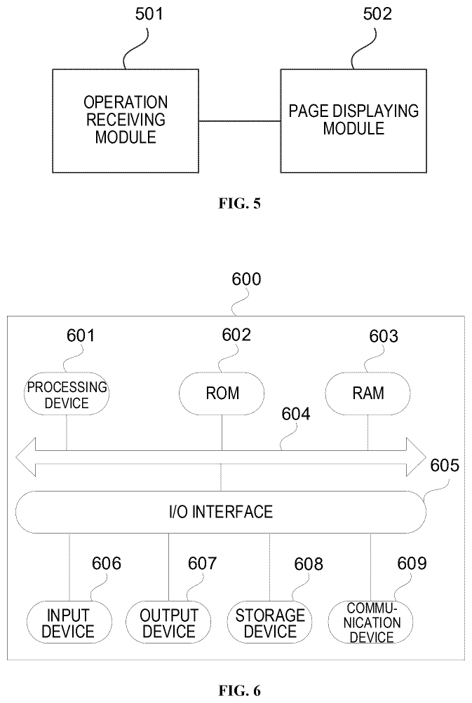

FIG. 5 is a structural block diagram of an apparatus for page display according to embodiments of the present disclosure. The apparatus may be implemented by software and/or hardware, may be configured in an electronic device, and is typically configured in a mobile phone or a tablet computer, and may display a background image and a foreground object in a page by performing a method for page display. For example, a background image is displayed in a page, and a predetermined foreground object is displayed on an upper layer of the background image. As shown in FIG. 5, the apparatus for page display provided in the embodiments may include an operation receiving module 501 and a page displaying module 502.

The operation receiving module 501 is configured to receive a display operation for a predetermined page.

The page displaying module 502 is configured to display, in response to the display operation, the predetermined page, display a background image in a background region of the predetermined page, and display a predetermined foreground object in a foreground region of the predetermined page, wherein the background region comprises a first sub-region and a second sub-region, the first sub-region is an associated sub-region of the foreground region in the background region, the background image displayed in the first sub-region is a gradient image, a gradient color corresponding to the gradient image is associated with a dominant color of a first picture region in a predetermined picture and a predetermined display color of the predetermined foreground object, and the background image displayed in the second sub-region is an original image of a second picture region in the predetermined picture.

In the apparatus for page display provided in the embodiments, the operation receiving module receives the display operation for the predetermined page; the page displaying module displays the predetermined page in response to the display operation, displays the background image in the background region of the predetermined page, and displays the predetermined foreground object in the foreground region of the predetermined page. The background region includes a first sub-region and a second sub-region, the first sub-region is an associated sub-region of the foreground region in the background region, the background image displayed in the first sub-region is a gradient image, the gradient color corresponding to the gradient image is associated with the dominant color of the first picture region in the predetermined picture and the predetermined display color of the predetermined foreground object, and the background image displayed in the second region is the original picture of the second picture region in the predetermined picture. By adopting the solution, the gradient color adopted for adjusting the background image is determined according to the dominant color in a certain picture region of the predetermined picture, such that the situation that the color change between the background image obtained through adjustment and the original image of the predetermined picture is too abrupt can be avoided. The coordination between the adjusted background image and the original image of the predetermined picture is improved, and the overall display effect of the background image in the background region is improved.

In the above solution, the background image may be obtained by superimposing a gradient mask on an upper layer of the predetermined picture, and the gradient padding is filled in a region corresponding to the first sub-region in the gradient mask layer.

In the above solution, the first sub-region may be located within a third sub-region of the background region, and the third sub-region is a display region corresponding to the first picture region in the background region.

Further, the apparatus for page display in the embodiments may further include: a dominant color obtaining module configured to obtain the dominant color of the first picture region in the predetermined picture before the background image is displayed in the background region of the predetermined page; a target color determination module configured to determine a target color according to the dominant color; and a gradient change generating module configured to generate a gradient color corresponding to the target color as the gradient color corresponding to the gradient image.

In the above solution, the target color determination module may be configured to perform at least one of the following: keeping a hue of the dominant color unchanged, and reducing a saturation and a lightness of the dominant color to obtain the target color in accordance with a color contrast between the predetermined display color of the foreground object and the dominant color being greater than or equal to a predetermined contrast threshold; keeping the hue of the dominant color unchanged, adjusting the saturation of the dominant color to a first saturation value, and adjusting the lightness of the dominant color to a first lightness value to obtain the target color in accordance with the color contrast between the predetermined display color of the foreground object and the dominant color being less than the predetermined contrast threshold, the saturation of the dominant color being less than or equal to a first saturation threshold, and the lightness of the dominant color being greater than or equal to a first lightness threshold.

In the above solution, the predetermined display color of the predetermined foreground object may be white, and the target color determination module may be configured to perform at least one of: keeping a hue of the dominant color unchanged, adjusting a saturation of the dominant color to a second saturation value, and reducing a lightness of the dominant color to obtain the target color in accordance with the saturation of the dominant color being less than or equal to a second saturation threshold, and the lightness of the dominant color being greater than or equal to a second lightness threshold; determining the dominant color as the target color in accordance with the saturation of the dominant color being greater than the second saturation threshold, or the lightness of the dominant color being less than the second lightness threshold.

In the above solution, there may be an overlapping region between the background region and the foreground region, and the overlapping region may be located within the first sub-region.

The apparatus for page display provided by the embodiments of the present disclosure may perform the method for page display provided by any embodiment of the present disclosure, and has functional modules and beneficial effects corresponding to the method for page display. For technical details not described in detail in the embodiments, reference may be made to the method for page display provided by any embodiment of the present disclosure.

According to the method, apparatus, electronic device and the storage medium for page display provided by the embodiments of the disclosure, the display operation for the predetermined page is received. In response to the display operation, the predetermined page is displayed, the background image is displayed in the background region of the predetermined page, and the predetermined foreground object is displayed in the foreground region of the predetermined page. The background region comprises a first sub-region and a second sub-region, the first sub-region is an associated sub-region of the foreground region in the background region, the background image displayed in the first sub-region is a gradient image, the gradient color corresponding to the gradient image is associated with the main color of the first picture region in the predetermined picture and the predetermined display color of the predetermined foreground object, and the background image displayed in the second region is the original picture of the second picture region in the predetermined picture. By adopting the solution, the gradient color adopted for adjusting the background image is determined according to the dominant color in a certain picture region of the predetermined picture, such that the situation that the color change between the background image obtained through the adjustment and the original image of the predetermined picture is too abrupt can be avoided. The coordination between the adjusted background image and the original image of the predetermined picture is improved, and the overall display effect of the background image in the background region is improved.

FIG. 6 is a schematic structural diagram of an electronic device (for example, a terminal device) 600 suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 6 is merely an example, and should not impose any limitation on the functions and scope of use of the embodiments of the present disclosure.

As shown in FIG. 6, the electronic device 600 may include a processing device (for example, a central processing unit, a graphics processor, etc.) 601, which may perform various appropriate actions and processing according to a program stored in a read-only memory (ROM) 602 or a program loaded into a random access memory (RAM) 603 from a storage device 608. In the RAM 603, various programs and data required by the operation of the electronic device 600 are also stored. The processing device 601, the ROM 602, and the RAM 603 are connected to each other through a bus 604. Input/output (I/O) interface 605 is also connected to bus 604.

Generally, the following devices may be connected to the I/O interface 605: an input device 606 including, for example, a touch screen, a touchpad, a keyboard, a mouse, a camera, a microphone, an accelerometer, a gyroscope, etc.; an output device 607 including, for example, a liquid crystal display (LCD), a speaker, a vibrator, etc.; a storage device 608 including, for example, a magnetic tape, a hard disk, etc.; and a communication device 609. The communication device 609 may allow the electronic device 600 to communicate wirelessly or wired with other devices to exchange data. While FIG. 6 shows an electronic device 600 having various devices, it should be understood that it is not required to implement or have all illustrated devices. More or fewer devices may alternatively be implemented or provided.

In particular, according to embodiments of the present disclosure, the process described above with reference to the flowchart may be implemented as a computer software program. For example, embodiments of the present disclosure include a computer program product comprising a computer program embodied on a non-transitory computer readable medium, the computer program comprising program code for performing the method shown in the flowchart. In such embodiments, the computer program may be downloaded and installed from the network through the communication device 609, or installed from the storage device 608, or from the ROM 602. When the computer program is executed by the processing apparatus 601, the foregoing functions defined in the method of the embodiments of the present disclosure are performed.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

In some implementations, the client, server may communicate using any currently known or future developed network protocol, such as HTTP (HyperText Transfer Protocol), and may be interconnected with any form or medium of digital data communication (e.g., a communication network). Examples of communication networks include local region networks (“LANs”), wide region networks (“WANs”) , internets (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer readable medium carries one or more programs, and when the one or more programs are executed by the electronic device, the electronic device is caused to: receive a display operation for a predetermined page; in response to the display operation, display a predetermined page, display a background image in a background region of the predetermined page, and display a predetermined foreground object in a foreground region of the predetermined page, wherein the background region comprises a first sub-region and a second sub-region, the first sub-region is an associated sub-region of the foreground region in the background region, a background image displayed in the first sub-region is a gradient image, a gradient color corresponding to the gradient image is associated with a dominant color of a first picture region in a predetermined picture and a predetermined display color of the predetermined foreground object, and a background image displayed in the second sub-region is an original picture of a second picture region in the predetermined picture.

Computer program code for performing the operations of the present disclosure may be written in one or more programming languages, including, but not limited to, object oriented programming languages such as Java, Smalltalk, C ++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local region network (LAN) or a wide region network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. The name of the module does not constitute a limitation on the unit itself in some cases.

The functions described above may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to one or more embodiments of the present disclosure, an example 1 provides a method for page display, including: receiving a display operation for a predetermined page; and displaying a predetermined page in response to the display operation, displaying a background image in a background region of the predetermined page and displaying a predetermined foreground object in a foreground region of the predetermined page, wherein the background region comprises a first sub-region and a second sub-region, the first sub-region is an associated sub-region of the foreground region in the background region, the background image displayed in the first sub-region is a gradient image, a gradient color corresponding to the gradient image is associated with a dominant color of a first picture region in a predetermined picture and a predetermined display color of the predetermined foreground object, and the background image displayed in the second sub-region is an original image of a second picture region in the predetermined picture.

According to one or more embodiments of the present disclosure, in example 2 of the method according to example 1, the background image is obtained by superimposing a gradient mask layer on an upper layer of the predetermined picture, and the gradient color is filled in a region of the gradient mask layer corresponding to the first sub-region.

According to one or more embodiments of the present disclosure, in example 3 of the method of example 2, the first sub-region is located within a third sub-region of the background region, and the third sub-region is a display region corresponding to the first picture region in the background region.

According to one or more embodiments of the present disclosure, in example 4 of the method of example 1, the method further comprises: before displaying the background image in the background region of the predetermined page: obtaining the dominant color of the first picture region in the predetermined picture; determining a target color according to the dominant color; and generating a gradient color corresponding to the target color as the gradient color corresponding to the gradient image.

According to one or more embodiments of the present disclosure, in example 5 of the method according to example 4, wherein determining the target color according to the dominant color comprises at least one of the following: keeping a hue of the dominant color unchanged, and reducing a saturation and a lightness of the dominant color to obtain the target color in accordance with a color contrast between the predetermined display color of the foreground object and the dominant color being greater than or equal to a predetermined contrast threshold; or keeping the hue of the dominant color unchanged, adjusting the saturation of the dominant color to a first saturation value, and adjusting the lightness of the dominant color to a first lightness value to obtain the target color in accordance with the color contrast between the predetermined display color of the foreground object and the dominant color being less than the predetermined contrast threshold, the saturation of the dominant color being less than or equal to a first saturation threshold, and the lightness of the dominant color being greater than or equal to a first lightness threshold.

According to one or more embodiments of the present disclosure, in example 6 of the method according to example 4, the predetermined display color of the predetermined foreground object is white, and determining the target color according to the dominant color comprises at least one of the following: keeping a hue of the dominant color unchanged, adjusting a saturation of the dominant color to a second saturation value, and reducing a lightness of the dominant color to obtain the target color in accordance with the saturation of the dominant color being less than or equal to a second saturation threshold, and the lightness of the dominant color being greater than or equal to a second lightness threshold; or determining the dominant color as the target color in accordance with the saturation of the dominant color being greater than the second saturation threshold, or the lightness of the dominant color being less than the second lightness threshold.

According to one or more embodiments of the present disclosure, in example 7 of the method according to any one of examples 1-6, wherein an overlapping region exists between the background region and the foreground region, and the overlapping region is located within the first sub-region.

According to one or more embodiments of the present disclosure, an example 8 provides an apparatus for page display, including: an operation receiving module, configured to receive a display operation for a predetermined page; and a page displaying module, configured to display a predetermined page in response to the display operation, display a background image in a background region of the predetermined page, and display a predetermined foreground object in a foreground region of the predetermined page, where the background region includes a first sub-region and a second sub-region, the first sub-region is an associated sub-region of the foreground region in the background region, a background image displayed in the first sub-region is a gradient image, a gradient color corresponding to the gradient image is associated with a dominant color of a first picture region in a predetermined picture and a predetermined display color of the predetermined foreground object, and a background image displayed in the second sub-region is an original picture of a second picture region in the predetermined picture.

According to one or more embodiments of the present disclosure, an example 9 provides an electronic device, including: one or more processors; a memory configured to store one or more programs. When the one or more programs are executed by the one or more processors, the one or more processors implement the method for page display according to any one of examples 1-7.

According to one or more embodiments of the present disclosure, an example 10 provides a computer-readable storage medium having stored thereon a computer program, which when executed by a processor, implements the method for page display according to any one of examples 1-7.

The above description is merely an illustration of the preferred embodiments of the present disclosure and the principles of the applied technology. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1-10. (canceled)

11. A method for page display, comprising:
receiving a display operation for a predetermined page; and
displaying, in response to the display operation, the predetermined page, displaying a background image in a background region of the predetermined page and displaying a predetermined foreground object in a foreground region of the predetermined page, wherein the background region comprises a first sub-region and a second sub-region, the first sub-region is an associated sub-region of the foreground region in the background region, the background image displayed in the first sub-region is a gradient image, a gradient color corresponding to the gradient image is associated with a dominant color of a first picture region in a predetermined picture and a predetermined display color of the predetermined foreground object, and the background image displayed in the second sub-region is an original image of a second picture region in the predetermined picture.

12. The method according to claim 11, wherein the background image is obtained by superimposing a gradient mask layer on an upper layer of the predetermined picture, and the gradient color is filled in a region of the gradient mask layer corresponding to the first sub-region.

13. The method according to claim 12, wherein the first sub-region is located within a third sub-region of the background region, and the third sub-region is a display region corresponding to the first picture region in the background region.

14. The method according to claim 11, wherein the method further comprises:
before displaying the background image in the background region of the predetermined page,
obtaining the dominant color of the first picture region in the predetermined picture;
determining a target color according to the dominant color; and
generating a gradient color corresponding to the target color as the gradient color corresponding to the gradient image.

15. The method according to claim 14, wherein determining the target color according to the dominant color comprises at least one of the following:
keeping a hue of the dominant color unchanged, and reducing a saturation and a lightness of the dominant color to obtain the target color in accordance with a color contrast between the predetermined display color of the foreground object and the dominant color being greater than or equal to a predetermined contrast threshold; or
keeping the hue of the dominant color unchanged, adjusting the saturation of the dominant color to a first saturation value, and adjusting the lightness of the dominant color to a first lightness value to obtain the target color in accordance with the color contrast between the predetermined display color of the foreground object and the dominant color being less than the predetermined contrast threshold, the saturation of the dominant color being less than or equal to a first saturation threshold, and the lightness of the dominant color being greater than or equal to a first lightness threshold.

16. The method according to claim 14, wherein the predetermined display color of the predetermined foreground object is white, and determining the target color according to the dominant color comprises at least one of the following:
keeping a hue of the dominant color unchanged, adjusting a saturation of the dominant color to a second saturation value, and reducing a lightness of the dominant color to obtain the target color in accordance with the saturation of the dominant color being less than or equal to a second saturation threshold, and the lightness of the dominant color being greater than or equal to a second lightness threshold; or
determining the dominant color as the target color in accordance with the saturation of the dominant color being greater than the second saturation threshold, or the lightness of the dominant color being less than the second lightness threshold.

17. The method according to claim 11, wherein an overlapping region exists between the background region and the foreground region, and the overlapping region is located within the first sub-region.

18. An electronic device comprising:
at least one processor; and
a memory communicatively connected to the at least one processor; wherein the memory having stored thereon a computer program executable by the at least one processor, and the computer program is executed by the at least one processor to cause the at least one processor to perform operations comprisng:
receiving a display operation for a predetermined page; and
displaying, in response to the display operation, the predetermined page, displaying a background image in a background region of the predetermined page and displaying a predetermined foreground object in a foreground region of the predetermined page, wherein the background region comprises a first sub-region and a second sub-region, the first sub-region is an associated sub-region of the foreground region in the background region, the background image displayed in the first sub-region is a gradient image, a gradient color corresponding to the gradient image is associated with a dominant color of a first picture region in a predetermined picture and a predetermined display color of the predetermined foreground object, and the background image displayed in the second sub-region is an original image of a second picture region in the predetermined picture.

19. The electronic device according to claim 18, wherein the background image is obtained by superimposing a gradient mask layer on an upper layer of the predetermined picture, and the gradient color is filled in a region of the gradient mask layer corresponding to the first sub-region.

20. The electronic device according to claim 19, wherein the first sub-region is located within a third sub-region of the background region, and the third sub-region is a display region corresponding to the first picture region in the background region.

21. The electronic device according to claim 18, wherein the operations further comprise: before displaying the background image in the background region of the predetermined page,
obtaining the dominant color of the first picture region in the predetermined picture;
determining a target color according to the dominant color; and
generating a gradient color corresponding to the target color as the gradient color corresponding to the gradient image.

22. The electronic device according to claim 21, wherein determining the target color according to the dominant color comprises at least one of the following:
keeping a hue of the dominant color unchanged, and reducing a saturation and a lightness of the dominant color to obtain the target color in accordance with a color contrast between the predetermined display color of the foreground object and the dominant color being greater than or equal to a predetermined contrast threshold; or
keeping the hue of the dominant color unchanged, adjusting the saturation of the dominant color to a first saturation value, and adjusting the lightness of the dominant color to a first lightness value to obtain the target color in accordance with the color contrast between the predetermined display color of the foreground object and the dominant color being less than the predetermined contrast threshold, the saturation of the dominant color being less than or equal to a first saturation threshold, and the lightness of the dominant color being greater than or equal to a first lightness threshold.

23. The electronic device according to claim 21, wherein the predetermined display color of the predetermined foreground object is white, and determining the target color according to the dominant color comprises at least one of the following:
keeping a hue of the dominant color unchanged, adjusting a saturation of the dominant color to a second saturation value, and reducing a lightness of the dominant color to obtain the target color in accordance with the saturation of the dominant color being less than or equal to a second saturation threshold, and the lightness of the dominant color being greater than or equal to a second lightness threshold; or determining the dominant color as the target color in accordance with the saturation of the dominant color being greater than the second saturation threshold, or the lightness of the dominant color being less than the second lightness threshold.

24. The electronic device according to claim 18, wherein an overlapping region exists between the background region and the foreground region, and the overlapping region is located within the first sub-region.

25. A non-transitory computer-readable storage medium having computer instructions stored thereon, the computer instructions, when executed by a processor, implementing operations comprising:
receiving a display operation for a predetermined page; and
displaying, in response to the display operation, the predetermined page, displaying a background image in a background region of the predetermined page and displaying a predetermined foreground object in a foreground region of the predetermined page, wherein the background region comprises a first sub-region and a second sub-region, the first sub-region is an associated sub-region of the foreground region in the background region, the background image displayed in the first sub-region is a gradient image, a gradient color corresponding to the gradient image is associated with a dominant color of a first picture region in a predetermined picture and a predetermined display color of the predetermined foreground object, and the background image displayed in the second sub-region is an original image of a second picture region in the predetermined picture.

26. The storage medium according to claim 25, wherein the background image is obtained by superimposing a gradient mask layer on an upper layer of the predetermined picture, and the gradient color is filled in a region of the gradient mask layer corresponding to the first sub-region.

27. The storage medium according to claim 26, wherein the first sub-region is located within a third sub-region of the background region, and the third sub-region is a display region corresponding to the first picture region in the background region.

28. The storage medium according to claim 25, wherein the operations further comprise: before displaying the background image in the background region of the predetermined page,
obtaining the dominant color of the first picture region in the predetermined picture;
determining a target color according to the dominant color; and
generating a gradient color corresponding to the target color as the gradient color corresponding to the gradient image.

29. The storage medium according to claim 28, wherein determining the target color according to the dominant color comprises at least one of the following:
keeping a hue of the dominant color unchanged, and reducing a saturation and a lightness of the dominant color to obtain the target color in accordance with a color contrast between the predetermined display color of the foreground object and the dominant color being greater than or equal to a predetermined contrast threshold; or
keeping the hue of the dominant color unchanged, adjusting the saturation of the dominant color to a first saturation value, and adjusting the lightness of the dominant color to a first lightness value to obtain the target color in accordance with the color contrast between the predetermined display color of the foreground object and the dominant color being less than the predetermined contrast threshold, the saturation of the dominant color being less than or equal to a first saturation threshold, and the lightness of the dominant color being greater than or equal to a first lightness threshold.

30. The storage medium according to claim 28, wherein the predetermined display color of the predetermined foreground object is white, and determining the target color according to the dominant color comprises at least one of the following:
keeping a hue of the dominant color unchanged, adjusting a saturation of the dominant color to a second saturation value, and reducing a lightness of the dominant color to obtain the target color in accordance with the saturation of the dominant color being less than or equal to a second saturation threshold, and the lightness of the dominant color being greater than or equal to a second lightness threshold; or
determining the dominant color as the target color in accordance with the saturation of the dominant color being greater than the second saturation threshold, or the lightness of the dominant color being less than the second lightness threshold.
